(19) United States
(12) Patent Application Publication
(10) Pub. No.: US 2024/0401305 A1
(43) Pub. Date: Dec. 5, 2024

(54) Subsea Blower Device

(71) Applicant: JARALA AS, Trondheim (NO)

(72) Inventor: Tom Jacobsen, Trondheim (NO)

(21) Appl. No.: 18/695,379

(22) PCT Filed: Sep. 28, 2022
(86) PCT No.: PCT/NO2022/050223

§ 371 Date: Mar. 26, 2024

(30) Foreign Application Priority Data
Oct. 1, 2021 (NO) 20211179

(51) Int. Cl. E02F 3/88; E02F 5/10; E02F 5/28

(52) U.S. Cl. CPC E02F 3/8866; E02F 5/107; E02F 5/287

(57) ABSTRACT

Subsea blower device comprising at least one nozzle, at least one propel arranged to provide the nozzle with water, further comprising a chassis with belts for movement of the device along the seafloor. The device typically has at least one arm pivotally attached to the chassis so that the position of the arm in relation to a horizontal plane is adjustable, while the nozzle is attached to the arm.

### BACKGROUND

The disclosed embodiments relate to underwater blower devices.

There is often a need to excavate sediments on a seabed, for example to plan areas before installing structures, digging trenches before laying pipes and cables and uncovering buried pipes, cables and other structures. The sediments to be dug can vary from clay and silt to sand, gravel and stones.

A number of devices are known for dredging sediments at the seabed, including devices that make use of conventional centrifugal pumps as well as ejectors to establish suction power.

Prior art technology also includes blowers, which direct a powerful flow of water down towards the seabed to disintegrate sediments and blow them away, cf. NO 344 516 (Rotech).

An example of a prior art blower is US 2010/0139130 (Wagenaar) which concerns a blower which is lowered from a vessel, and which is also equipped with thrusters for its positioning. Another example is WO 2008/065360 (Susman) which is admittedly more focused on digging (excavation) than on blowing. Furthermore, reference is made to applicant's own publication, WO 2014/148916, which provides instructions for a blower designed in such a way that a field of acceptable visibility is maintained at the working point directly below the blower. This too is initially launched from a vessel and operates hoovering in the water sediments with control at least partially through the use of thrusters.

The disadvantage of prior art technology is partly that sediments are blown up into a cloud which quickly envelops the blower and makes it difficult to monitor the work visually. Furthermore, it is a problem that the ability to blow the material in a certain direction is highly limited, which often leads to the material falling back into the ditch or hole that one wants to keep clean and empty.

Furthermore, it can be a problem in the case of large waves or strong undercurrents to position the equipment precisely enough to carry out the task satisfactorily within a given period of time.

When working at great sea depths, it may also be difficult to position and manoeuvre conventional blowers sufficiently accurate as they are operated from a crane vessel at the surface.

### SUMMARY

The disclosure provides a device that blows the sediments further away and out of the area from which sediments are to be removed. It is intended that the remaining bottom is kept as intact as possible, and it is intended to retain visibility so that one can have control of the excavation around vulnerable objects. Additionally, the blower device is efficient in relation to its size.

Disclosed herein is a subsea blower device comprising a belt-driven chassis and preferably one, but optionally plural blowers arranged to blow water towards sediments, each comprising one or more propellers and typically one, but optionally also plural nozzles.

The blower typically comprises a unit where the propeller(s) and nozzle(s) are firmly connected to each other, typically mounted together in a cabinet that is sealed with the exception of the opening(s) into the propeller(s) and nozzle(s). However, it is also possible that the propeller(s) and nozzle(s) are connected by pipes or flexible hose(s), though this is less practical in most cases. Furthermore, the disclosed device can comprise several blowers, either on the same arm or on different arms. In order to simplify the subsequent description, various variants of a preferred embodiment primarily refer to a blower in the form of a single unit with one or more propellers arranged in a cabinet together with one or more nozzles.

The blower is arranged on a pivotal and/or articulated arm which is connected to a belt-driven chassis. The arm can be pivotal at least about one axis and possibly manoeuvred so that the blower may be aligned in different positions and angles in relation to the belt-driven chassis. Preferably, the arm carrying the blower is pivotal about a horizontal axis.

The nozzle(s) of the blower can have a dimension of several tens of cm in diameter, for example 10-80 cm, more preferably 20-60 cm and a length of the same order of magnitude to achieve a desired strong, collected parallel flow of water of large volume and modest pressure. Typical mass flow rates (of water) using the disclosed embodiments are from 0.5 to 10 m³/s at a linear velocity of 4-10 m/s.

The arm length can typically be of the order of 4-16 metres. However, there are no physical limitations that prevent smaller blowers and/or larger blowers.

The disclosed embodiments make it possible to blow sediments further away than what is possible with conventional blowers while maintaining visibility at the point of work. Furthermore, the sediments can be removed in the chosen and desired direction and with greater capacity than what has previously been possible. The above-mentioned properties help to reduce the problem of sediments falling back into the ditch, gutter or hole from which they are blown. At the same time, the embodiments make it possible to maintain visibility to a far greater extent than with conventional blowers.

The propeller or propellers supplying the nozzle(s) with water can be electrically or hydraulically powered. As the blower sits on a pivotal arm, the position and thus the flushing direction is adjustable. The arm is preferably hydraulically pivotal and manoeuvrable. Furthermore, the blower can sit on a pivotal foot or a pivotal joint which means that the direction of the water flow is adjustable both vertically and horizontally.

As mentioned, the propeller(s) and the nozzles can be arranged as an integrated unit, for example with a propeller arranged at the “bottom” of a nozzle, preferably in a special cylindrical cabinet which only has a cylinder wall, no end walls. Propellers can also be arranged perpendicular to the axis of the nozzle, either by arranging one or more nozzles around the cabinet or by having two opposite propellers on a common axis. Alternatively, one or more propellers can be arranged at a distance from one or more nozzles, supplying water to this or these via internal fluid passages or channels.

Most appropriately, during use the device will be so adjusted that the water flow hits the seabed/the sediments to be removed at an oblique angle, so that the sediments are blown away from the device. If there are current, it will be most appropriate to blow in the direction of the currents so that the current removes the fines that would otherwise obstruct visibility.

In many cases, sediments will be cohesive and «cemented». The water flow from the blower is suitable for moving large amounts of sediment and therefore does not have the pressure required to disintegrate hard (cohesive) sediments. The blower device can therefore be equipped with flushing nozzles which are designed to flush water under high pressure against the sediments in order to disintegrate them. Such flushing nozzle(s) can be arranged separately from the blower itself and possibly operated by separate arms, but they can also advantageously be arranged in connection with the blower, for example around the outlet of the nozzle. Such flushing nozzles would be designed to be supplied with water at a pressure that is adapted to the sediments to be disintegrated, which will typically be between 3 and 300 bar.

Instead of, or in addition to flushing nozzles, mechanical means may also be used to disintegrate sediments, such as hydraulically operated bucket with teeth, fixed or hydraulically operated, movable spikes, hydraulic hammers or rotating cutters (“cutterheads” or “drum-cutters”).

The present invention can be realized in many embodiments. According to one preferred embodiment, the device comprises only one blower nozzle.

### BRIEF DESCRIPTION OF THE DRAWINGS

In the following, the device is described in more detail with reference to the attached figures.

FIG. 1 is a schematic and simplified side view of a preferred embodiment of a device according to the disclosure.

FIG. 2 is a schematic and simplified top view of an embodiment which corresponds to the embodiment shown in FIG. 1.

FIG. 3 shows an alternative embodiment of a device according to the disclosure.

FIG. 4 shows an alternative embodiment of a device according to the disclosure.

FIG. 5 shows an alternative embodiment of a device according to the disclosure.

FIG. 6A shows an embodiment of a detail of a device according to the disclosure.

FIG. 6B shows an embodiment of a detail of a device according to the disclosure.

FIG. 6C shows an embodiment of a detail of a device according to the disclosure.

FIG. 7 shows an alternative embodiment of a detail of a device according to the disclosure.

FIG. 8A shows another alternative embodiment of a detail of a device according to the disclosure.

FIG. 8B shows yet another alternative embodiment of a detail of a device according to the disclosure.

FIG. 9 shows yet another alternative embodiment of a detail of a device according to the disclosure.

FIG. 10 shows a variant of the embodiment shown in FIG. 9.

FIG. 11 shows another alternative embodiment of a detail of a device according to the disclosure.

### DETAILED DESCRIPTION

By “schematic and simplified” is understood that the components are not necessarily shown in the correct size ratio or in their most appropriate position, while certain components that will naturally be present, such as components for the supply of electrical energy or hydraulic components, but which are not central to the definition of the invention, are omitted.

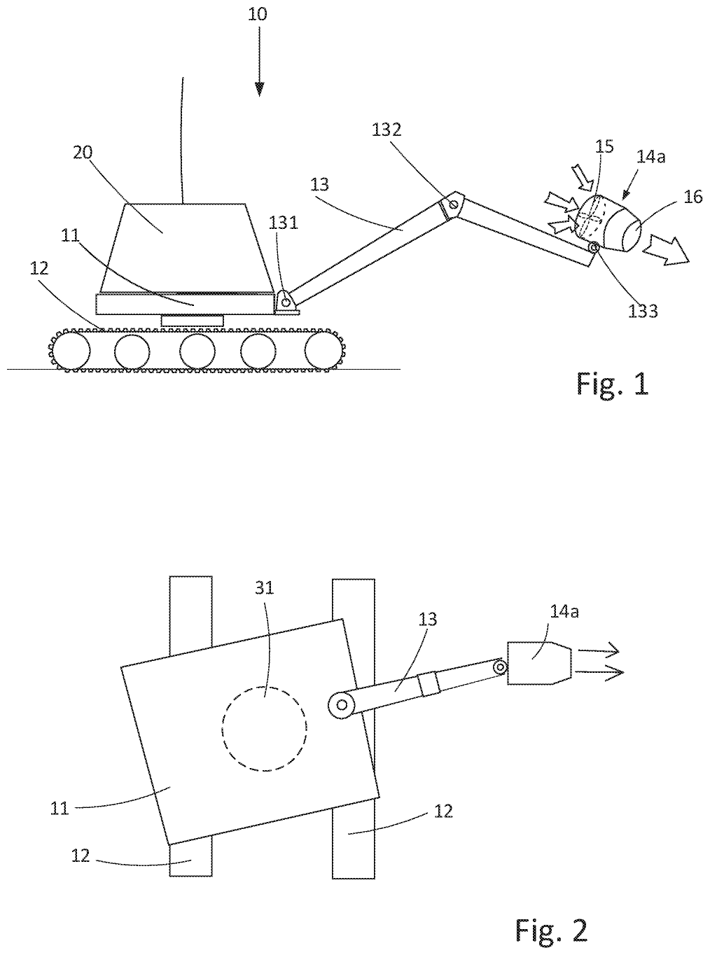

FIG. 1 shows an embodiment of a device where the arm 13 is multi-jointed with joints 131, 132 and where a blower 14a is mounted on the arm 13 via yet another pivotal joint 133 which provides further options for controlling the blowing flow from the blower 14a. A blower 14a as described herein, comprises a cabinet, at least one intake for water to at least one propeller 15 and at least one nozzle 16 for waterflow blowing. The embodiment shown in FIG. 1 also includes a housing 20 which can accommodate non-obligatory equipment for such a device such as couplings, motors, hydraulic power supply and compensators.

FIG. 2 is a top view of the device according to FIG. 1 with a pivotal chassis, pivotal arm and pivotal blower on the arm. This embodiment comprises a blower 14a with an associated propeller 15 and a nozzle 16. As can also be seen from the figure, the chassis 11 is mounted on a turntable 31 so that the direction of the arm can be controlled to different directions, also horizontally. Preferably, the turntable can turn at least 180 degrees and preferably unlimited. The housing 20 is not shown in FIG. 2.

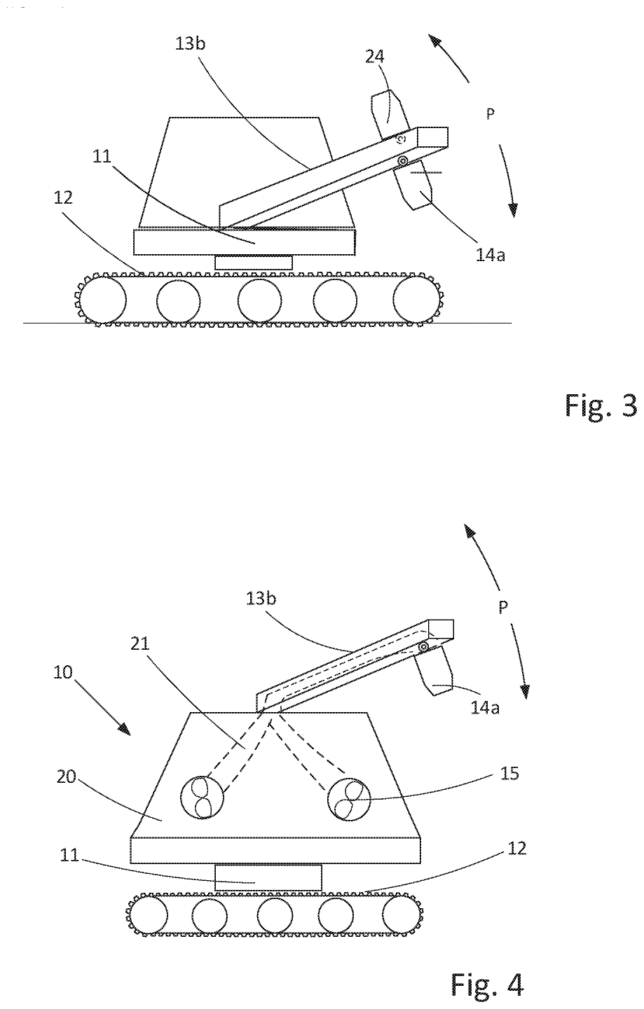

FIG. 3 shows an embodiment with an arm 13b which is only pivotally attached to the chassis 11, that is to say it does not include a joint corresponding to the joint 132 in FIG. 1. In addition to a blower 14a, it comprises a further blower 24 which is directed in the opposite direction. The purpose of the additional blower is to set up a counter force that at least partially balances the force acting from the blower 14a, so that an excessively large torque will not be transmitted to the chassis 11 and the belts 12, which could cause the entire blower assembly to overturn or rotate. This naturally requires additional energy input. The alternative would be to make the blower device more stable by adding extra mass, which also requires energy, and which makes the blower device less manageable both in water and on land.

As generally shown in FIG. 1, the propeller and nozzle may be made as integrated or size-matched units in a common cabinet.

FIG. 4 shows in a side view an embodiment which differs from the embodiments in FIGS. 1-3 in that the propeller 15 is arranged in the housing 20 mounted on the chassis and that the arm 13b. Water passages 21 lead from the propellers to the blower 14a for being supplied with water by one or more propellers. An advantage of this design is that the propellers can be sized independently of the size of the nozzles, while a disadvantage is that a pressure loss occurs on the way between the propeller and the nozzle.

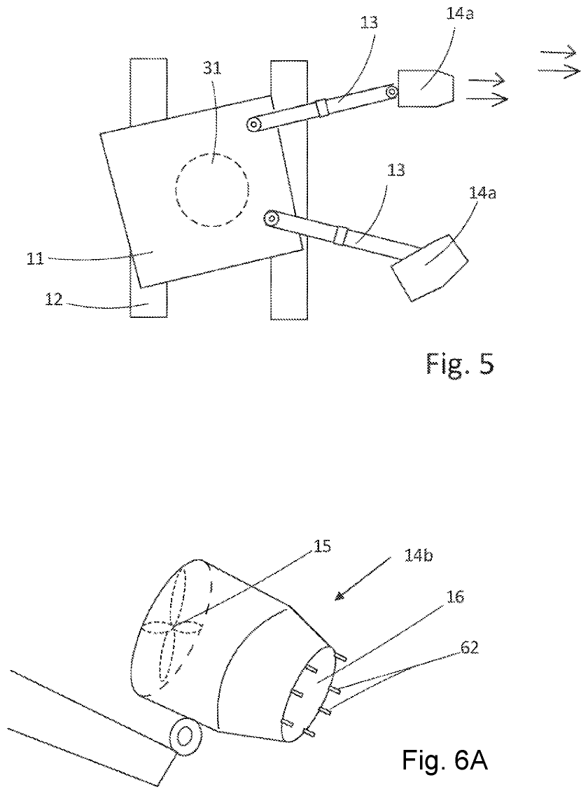

FIG. 5 shows a variant with two arms 13a and 13b with two blowers 14a arranged on two different arms 13. This configuration allows, for example, simultaneous blowing away to both sides from a pipe trench, a ditch or the like.

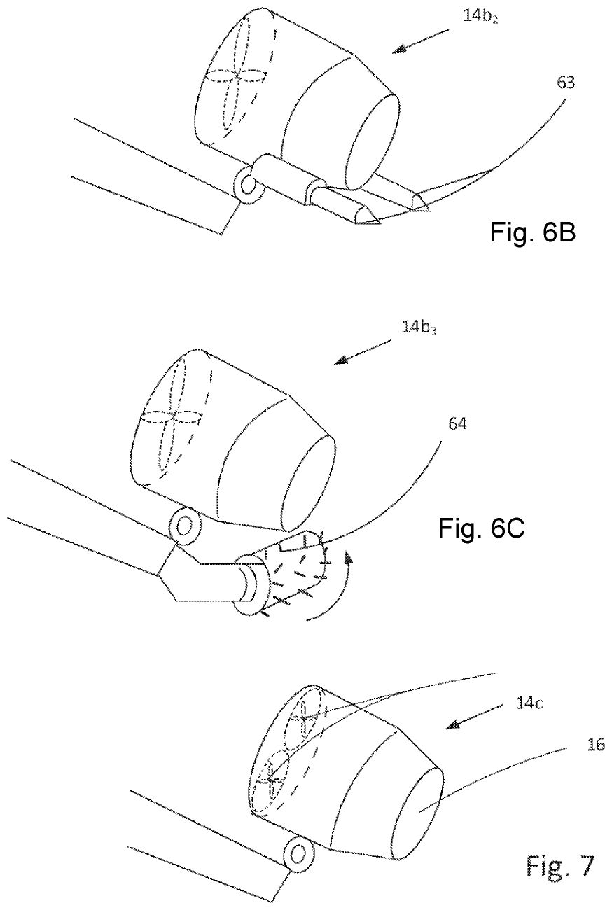

FIG. 6A shows an enlarged variant 14b of the blower where there is one propeller 15 at the intake opening and there is one nozzle 16 at the opposite end of the housing. The distinctive feature of this embodiment is that around the nozzle 16, a number of smaller nozzles 62 are arranged for high-pressure flushing to penetrate sediments. It is possible to combine the high-pressure flush nozzles with mechanical means for penetrating sediments.

FIG. 6B shows a variant of the device, such as that of FIG. 6A, where mechanical means such as spike hammers 63 are arranged to loosen hard sediments, concrete or rock.

FIG. 6C shows a further variant of the device, such as that of FIG. 6A, where rotating means 64 with teeth are used to loosen hard sediments, concrete or rock.

FIG. 7 shows another variant of a blower 14c where two propellers 15 are arranged side by side at the intake opening. It is naturally also possible to combine this variant with high-pressure spray nozzles and/or mechanical means for penetrating sediments.

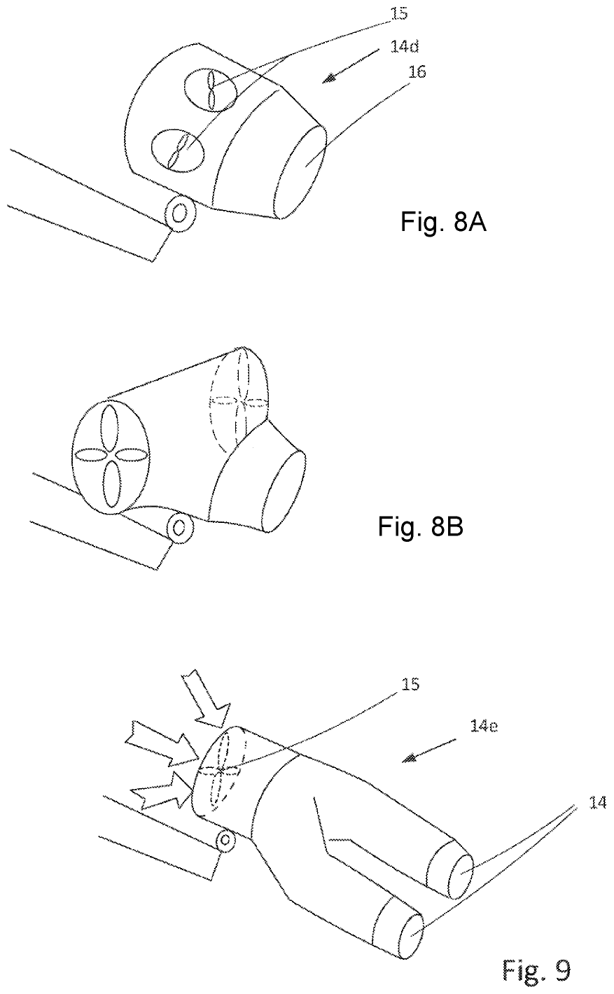

FIG. 8A shows yet another variant of a blower 14d where intake openings and propellers 15 are arranged on a circular surface of the cabinet which still includes only one nozzle 16. This configuration enables more than two intake openings/propellers.

FIG. 8B shows yet another variant of a blower 14d where intake openings and propellers 15 are arranged on an axis which is perpendicular to the nozzle.

FIG. 9 shows yet another variant of a blower 14e where there is one propeller at one intake opening and where the housing is branched into two nozzles 16 which are arranged to blow mainly in parallel.

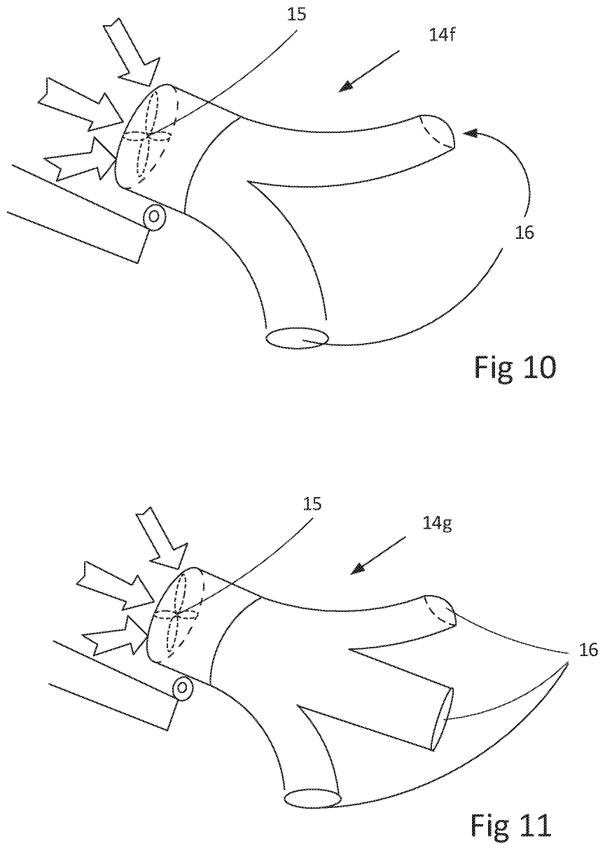

FIG. 10 shows a variant of the blowers in FIGS. 8A and 8B where the two nozzles 16 are arranged to blow in different directions, for example away to both sides of a pipe or the like along which the blower 14 is moved.

FIG. 11 shows a variant with 3 nozzles, a centre nozzle and two side nozzles that produce flow and that the sediments are removed to both sides. This variant is suitable for essentially the same purpose as that shown in FIG. 10, but ensures in particular that loose sediments are not left behind in the central area that the side nozzles do not cover.

There are a further number of combinations of disintegration means (FIGS. 6-6c) propellers (FIGS. 6A-8B) and nozzles (FIGS. 9-11) which are not described in detail here.

Common to all embodiments is that the arm 13 is pivotal with regard to its angle in relation to a horizontal plane. The arm 13, or alternatively the entire chassis 11 can also be turned laterally. Again alternatively, the blowers 14 can be pivotally attached to the arms 13, 13b so that a lateral control option for the water flow is achieved.

An advantage of the disclosed embodiments compared to the known ones is that one can completely avoid a vertical flow of water towards the bottom, which basically sends sediments in all directions from the point of impact towards the bottom and generates a cloud of sediments which largely obstructs visibility. When using the embodiments, one will exclusively operate with an inclined flow beam. This will cause a flow along the seabed generating suction that lifts/sucks up sediments, so that they can be blown away. The beam(s) can be directed in any desired direction, but typically away from the work area in question and preferably with the direction of the sea current.

The device is also suitable for covering, for example ditches, that need to be filled, which is not effective with blowers that send sediments in all directions. It can also be used where there is no access by boat, for example under platforms or in very shallow water.

The disclosed device allows very precise positioning since it is not affected by waves or ocean currents.

With the possibility of stepless adjustment of the angle of the arm in relation to the horizontal plane—and thus the direction of the water jet—one can achieve an almost optimal effect of the water jet under varying conditions.

1-14. (canceled)

15. A subsea blower device (10), comprising:
at least one nozzle (16);
at least one propeller (15) configured to supply the nozzle (16) with water; and
a chassis (11) with belts (12) for moving the device (10) along a bottom surface under water.

16. The device in accordance with claim 15, further comprising at least one arm (13) pivotally attached to the chassis (11), wherein at least one nozzle (16) is attached to the arm (13) and a position of the arm in relation to a horizontal plane is adjustable.

17. The device in accordance with claim 15, wherein an orientation of the nozzle (16) is adjustable by at least one hydraulic link (131, 132).

18. The device according to claim 17, wherein a nozzle (16) and a propeller (15) are mounted together in a cabinet forming a unit defining a blower (14a, 14b, 14c, 14d, 14e, 14f, 14g).

19. The device according to claim 16, wherein a nozzle (16) and a propeller (15) are mounted together in a cabinet forming a unit defining a blower (14a, 14b, 14c, 14d, 14e, 14f, 14g).

20. The device according to claim 15, further comprising a plurality of propellers (15), each propeller (15) being arranged separately or as part of a blower (14a, 14b, 14c, 14d, 14e, 14f, 14g).

21. The device according to claim 16, further comprising a plurality of propellers (15), each propeller (15) being arranged separately or as part of a blower (14a, 14b, 14c, 14d, 14e, 14f, 14g).

22. The device according to claim 15, wherein the at least one propeller (15) is hydraulically or electrically powered.

23. The device according to claim 16, wherein the at least one propeller (15) is hydraulically or electrically powered.

24. The device according to claim 20, wherein the propellers (15) are hydraulically or electrically powered.

25. The device according to claim 15, wherein the at least one nozzle is only one nozzle (16).

26. The device according to claim 16, wherein the at least one nozzle is only one nozzle (16).

27. The device according to claim 15, wherein the device comprises more than one nozzle (16), each nozzle (16) being arranged separately or as part of a blower (14a, 14b, 14c, 14d, 14e, 14f, 14g).

28. The device according to claim 15, comprising one or more flushing nozzles (62) arranged to be supplied with water under a pressure that is higher than a pressure of water supplied to the at least one nozzle (16).

29. The device in accordance with claim 28, wherein the spray nozzles (62) are arranged around an outlet of at least one of the at least one nozzle (16) of the blower (14b).

30. The device according to claim 15, further comprising one or more of fixed or movable spikes, bucket with teeth and rotators configured for disintegrating sediments.

31. The device according to claim 15, wherein the device is configured to generate a mass flow rate of water within an approximate range of 0.5 to 10m³/s at an approximate linear speed within a range of 4 to 10 m/s.

32. The device according to claim 15, wherein at least one of the at least one nozzle (16) has a diameter within an approximate range of 10 to 80 cm

33. The device according to claim 32, wherein the least one nozzle (16) has a diameter within an approximate range of 20 to 60 cm.

34. The device according to claim 15, wherein at least one of the at least one nozzle (16) is oriented at an angle in relation to a horizontal axis so that the sediments are blown in the desired direction.
